(19) United States
(12) Patent Application Publication
(10) Pub. No.: US 2010/0031349 A1
(43) Pub. Date: Feb. 4, 2010

(54) Method and Apparatus for Secure Data Storage System

(75) Inventor: Gregory C. Bingham, Gilbert, AZ (US)

Correspondence Address: Robert D. Atkins, 605 W. Knox Road, Suite 104, Tempe, AZ, 85284, US

(73) Assignee: WHITE ELECTRONIC DESIGNS CORPORATION, Phoenix, AZ (US)

(21) Appl. No.: 12/181,533

(22) Filed: Jul. 29, 2008

(51) Int. Cl. G06F 21/00

(52) U.S. Cl. 726/20

(57) ABSTRACT

A secure storage system includes a storage device having a communication device and a memory. The communication device is for polling a communication medium. A security token is received from the communication medium via the communication device of the storage device. The security token received from the communication medium is compared to a second security token stored on the storage device. In one embodiment, a current location of the storage device is determined. The current location of the storage device is compared to an approved security zone. Access to the memory is provided if the security token received from the communication medium matches the second security token stored on the storage device and the current location of the storage device lies within the approved security zone. A time-out counter is set to a non-zero value after access to the memory is provided.

### FIELD OF THE INVENTION

The present invention relates in general to data storage systems and, specifically, to secure data storage systems including a key in communication with a storage device.

### BACKGROUND OF THE INVENTION

Portable data storage devices allow for the convenient transportation of significant quantities of data. Common portable storage devices include flash memory drives, external hard drives, solid state drives, SmartMedia cards, Memory Sticks, and miniSD or microSD memory cards. Each storage device includes a memory circuit or structure for storing data, a controller for managing and accessing the memory, and a connector for connecting to other system components. As semiconductor fabrication technologies improve, increasing amounts of information can be stored in a smaller footprint allowing for the manufacture of portable storage devices with improved storage capacity and performance. Modern semiconductor fabrication technologies allow for the formation of a compact portable storage device that is small enough to fit on a key chain, or in an individual's pocket.

Modern portable storage devices can store tens of gigabytes of data allowing voluminous data collections to be transported using a single compact device. The devices can also be connected to computer systems and used in place of traditional data drives to store pure data, databases, or even operating systems and programs that may be used by the connected computer system. In secure situations, the use of a portable storage device may be a preferred method to communicate data. If the data were to be transferred over a computer network, for example, the data may be intercepted by an attacker with access to the network. Similarly, business people or individuals may choose to store their personal or confidential information on a portable storage device rather than store the information on a computer system that may be accessible to other individuals or system administrators.

Unfortunately, because the portable storage devices are manufactured in small and convenient form factors, the devices are easily misplaced, lost or stolen. If the device contains a large amount of confidential or personal data, the loss of such a device could lead to identity theft, loss of trade secrets, financial fraud, and embarrassment. If the device includes military information, loss of the device could lead to the enemy learning military strategy which could have disastrous results. Similarly, businesspeople will often store company trade secrets or business confidential information on portable storage devices. If, for example, a company has departments located in several countries, employees may regularly travel between the departments to make presentations, collect data, or otherwise share confidential information. If the data is voluminous, an employee can store the data on a portable storage device that is easily packed in the employee's luggage. Unfortunately, the luggage or the storage device can be easily stolen, lost, or misplaced. If the device is misplaced, a competitor may get access to and use the confidential information. Accordingly, the consequences of a lost portable storage device are substantial as a company can lose intellectual property rights, trade secrets, or otherwise lose a competitive advantage. Accordingly, it is important that data stored on a portable storage device be protected.

Currently, there exist several passive mechanisms that protect information stored on a portable storage device. For example, the data may be encrypted to prevent another from easily retrieving the data stored on the device. Encryption is not always a perfect solution, however, as it can be difficult to implement. Often users will choose to bypass encryption protection for personal convenience. Similarly, users will often use simple or easy to guess passwords that are easy to remember, but which make brute force password attacks much easier. Also, with possession of the storage device, potential attackers have permanent access to the encrypted data. Accordingly, if a weakness should be discovered in the encryption algorithm at some future date, the attackers can exploit the weakness to access the data. Similarly, the attackers can take the time to run brute force attacks against the encrypted data in an attempt to access the original data content. Other portable storage devices include physical interfaces to prevent access to the data without authentication. Some devices include fingerprint readers or keypads that must be used before access to the data is granted. All these implementations, however, are passive and leave the potential attacker in permanent possession of the data. Attackers are free to continue probing the device to discover exploits for retrieving the original data. If exploits for the passive protection systems are ultimately discovered, the attacker can use the exploit to access the data. Accordingly, in situations where portable storage devices contain sensitive or secret information, existing protection systems only provide passive protection and do not prevent an attacker from using then known or later-discovered techniques for breaking the protection and accessing the original data.

In one configuration, conventional portable storage devices include a memory array for storing information, and a controller for accessing and modifying the memory. An interconnect port allows external system components to communicate with the controller to retrieve and modify data stored by the memory. FIG. 1 shows a block diagram of a conventional portable storage device. Storage device 2 includes memory 4 for storing data. Memory 4 generally includes nonvolatile memory circuitry such as an electronically erasable programmable read-only memory (EEPROM) array. Memory 4 includes millions of memory cells, each memory cell being configured to store a single bit of information. In flash-based memory devices, each bit of information is stored using a floating-gate transistor. The floating-gate transistor includes electronic inputs for setting the transistor to a particular value and/or erasing the information stored by the transistor. The cells of memory 4 are arranged in an addressable fashion allowing external components to interact with the individual cells of memory 4, or a collection of cells. As shown in FIG. 1, controller 6 is connected to memory 4 to retrieve data from and to modify values stored within memory 4. Because memory 4 is addressable, controller 6 can retrieve or modify values stored in specific locations within memory 4. Controller 6 is connected to interconnect port 8. Interconnect port 8 includes USB adapters, hard drive connectors such as ATA or SCSI adapters, or other electronic connectors and is configured to connect storage device 2 to other system components. After storage device 2 is connected to other system components, the external components access the data stored on storage device 2. Because controller 6 acts as an intermediary for storage device 2, the external system components do not interact with memory 4 directly. Instead, they issue requests for data or instructions to modify values stored in memory 4 directly to controller 6. Upon receiving the instructions from the external components, controller 6 interacts with memory 4 to execute the instructions. By acting as an intermediary, controller 6 provides a single, consistent interface to memory 4. Even if the configuration of memory 4 is changed from one device to the next, the external system continues to communicate with controller 6 using the same or similar commands. Controller 6 then translates the commands and accesses memory 4 accordingly. Controller 6 may provide additional functionality to storage device 2 by providing wear leveling, write verification and remapping for memory 4. One or more passive security systems may be implemented by or coupled to controller 6 to protect information stored in memory 4 of storage device 2.

### SUMMARY OF THE INVENTION

In one embodiment, the present invention is a method of providing a secure storage system comprising providing a storage device having a communication device and a memory. The communication device is for polling a communication medium. The method includes receiving a security token from the communication medium via the communication device of the storage device, and comparing the security token received from the communication medium to a second security token stored on the storage device. The method includes determining a current location of the storage device, and comparing the current location of the storage device to an approved security zone. The method includes providing access to the memory if the security token received from the communication medium matches the second security token stored on the storage device and the current location of the storage device lies within the approved security zone.

In another embodiment, the present invention is a method of providing a secure storage system comprising providing a storage device having a communication device and a memory. The communication device is for polling a communication medium. The method includes receiving a security token from the communication medium via the communication device, and comparing the security token received from the communication medium to a second security token stored on the storage device. The method includes providing access to the memory if the security token received from the communication medium matches the second security token stored on the storage device.

In another embodiment, the present invention is a method of providing a secure storage system comprising providing a storage device, and receiving a security token from a communication medium. The method includes comparing the security token received from the communication medium to a second security token, and providing access to the storage device if the security token received from the communication medium matches the second security token.

In another embodiment, the present invention is a secure storage system comprising a storage device having a communication device and a memory. The communication device is for polling a communication medium. The secure storage system includes a processor for comparing a security token received from the communication medium to a second security token stored on the storage device. The processor provides access to the memory if the security token received from the communication medium matches the second security token stored on the storage device.

### BRIEF DESCRIPTION OF THE DRAWINGS

FIG. 1 illustrates a conventional data storage system having a memory, controller and a connector for connecting to external computer systems or other system components;

FIG. 2 illustrates a secure data storage system including a storage device and a key, the storage device and the key communicate via a communication medium;

FIG. 3a illustrates a secure data storage system including a storage device and a key, the storage device includes an antenna device for communicating wirelessly with the key;

FIG. 3b illustrates a flow chart showing a series of steps for receiving a security token from a key and using the security token to grant access to data on a storage device;

FIGS. 4a-4b illustrate a secure data storage system including a storage device and a key, each storage device includes a global positioning system (GPS) for determining a current location of the storage device;

FIG. 5 illustrates an embodiment of a secure data storage system including a storage device and a key, the storage device includes a user interface for receiving a password or security token entered by a user; and

FIG. 6 illustrates a computer system having an integrated secure data storage system, the secure data storage system includes a storage device and a key, the key is mounted to a motherboard of the computer system.

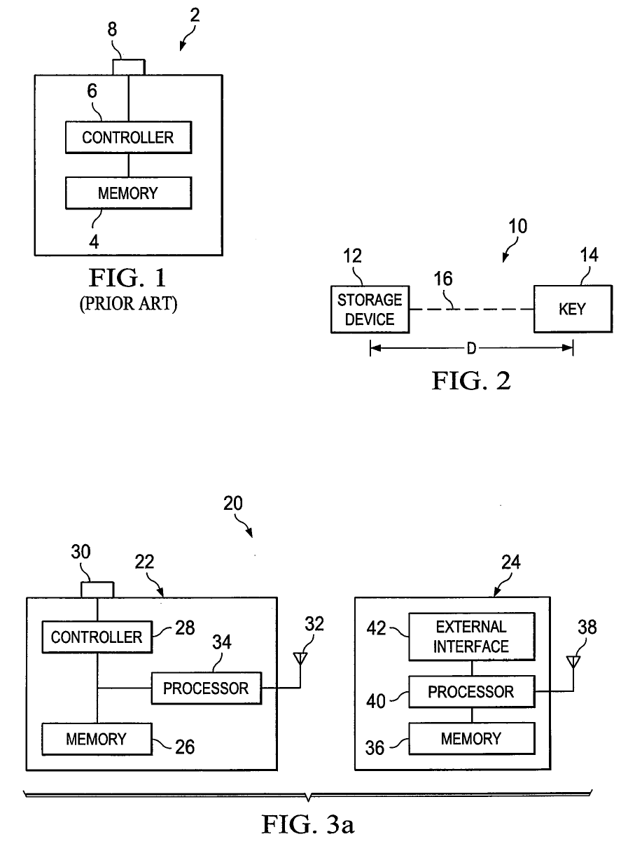

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Although portable storage devices provide a convenient means for transporting large quantities of data, they also present significant security concerns. If a portable storage device is stolen or lost, the data stored thereon may be accessed and used for financial fraud, blackmail, or, in the case of military secrets, deadly attacks. Businesspeople often use portable storage devices as a convenient mechanism for transporting large quantities of confidential information or trade secrets between company facilities, partners, suppliers, or other entities that are authorized to view the information. The portable storage devices allow employees to conveniently transport presentations, sales or marketing data, and other information necessary for the efficient operation of the business. The loss of such a portable storage device could have harmful consequences for a business as it could lead to loss of trade secrets, intellectual property, and other sources of competitive advantage. Even if the data on the portable storage device is protected by encryption, intrusion detection devices, or other passive security systems, the thief or attacker continues to have possession of the device and can take an extended period of time to probe the device looking for security exploits. As the security community publishes new exploits for the implemented passive security systems, the attacker may use that information to access the device. In short, even if the storage device includes passive protections, after it is stolen, the data is in immediate and ongoing jeopardy. Conventional portable storage devices do not include mechanisms for actively protecting their data. The devices also have no mechanism for determining whether they have been stolen, or whether an attempt to access data comes from an attacker, or a legitimate user. Accordingly, the storage devices must rely upon passive systems to protect any data.

FIG. 2 illustrates a secure portable memory system 10. The secure memory system 10 includes storage device 12 and key 14. In many respects, storage device 12 resembles a conventional portable storage system. Key 14 is a key-fob or other small electronic device that can be conveniently carried separate from storage device 12. In its default state and without key 14, storage device 12 denies all data access. To access the data on storage device 12, a user must first place the appropriate key 14 in communication with storage device 12. In one embodiment, wherein storage device 12 and key 14 communicate wirelessly, this is done by bringing key 14 and storage device 12 in close proximity so that the devices can communicate data. If storage device 12 and key 14 communicate via a cable, for example, key 14 is directly connected to storage device 12 via the cable. After key 14 is placed in communication with storage device 12, storage device 12 receives the appropriate security token from key 14 and grants a user access to the data. If storage device 12 determines it is no longer in communication with key 14, storage device 12 acts unilaterally and proactively to protect the data by encrypting, or even erasing the data to ensure it is fully protected.

In this configuration, the secure portable memory system 10 provides a user with a system for protecting data on storage device 12. If storage device 12 is taken out of communication with key 14 (for example, by theft of storage device 12), storage device 12 takes action to protect the data with no user intervention. The system is simple to use and requires little or no user management. Conventional storage systems only offer passive security systems which, after theft of a storage device, give the attacker continued access to the storage device and the protected data. In his or her own time, the attacker can probe the device looking for security exploits and can take advantage of new exploits as they are made available. Similarly, passive security systems may be difficult to implement and, in the case of encryption may be routinely bypassed or weakened by frustrated or confused users. In the present system, however, storage device 12 and key 14 both act proactively and unilaterally to protect the data with little or no impact on the user experience. If storage device 12 fails to detect the appropriate key 14, it will, without any user-intervention, lock or erase the data, making it inaccessible to a potential attacker. Similarly, in some embodiments, key 14 automatically and independently transmits instructions or commands to storage device 12 causing it to lock the device to prevent data access.

In the present embodiment, storage device 12 has a similar form factor as conventional portable storage devices including flash memory drives, external hard drives, solid state drives, or SmartMedia cards and includes an access-control processor and a connector for connecting to a computer system. By default, storage device 12 is locked and does not allow access to its data. In order to unlock storage device 12, key 14 must be placed in communication with storage device 12 and a security token must be passed from key 14 to storage device 12. Without the security token, storage device 12 prevents all access to the data. Key 14 communicates with storage device 12 wirelessly or via a wired connection. In both cases, key 14 and storage device 12 are configured to only communicate if the distance between the devices is below a defined threshold. The threshold may be equal to, or less than the maximum communication range of each device. In other words, storage device 12 only operates if key 14 is within a defined zone formed around storage device 12. During operation, key 14 continually broadcasts security tokens via communication medium 16 which may be detected by storage device 12. Upon receiving the correct security token, storage device 12 unlocks the data and allows a connected computer system access. When unlocked, storage device 12 operates as a conventional portable storage device and a connected computer system may retrieve, modify or delete information on storage device 12. Storage device 12 is only unlocked when it is in consistent communication with key 14. If key 14 is taken out of communication range with storage device 12 (which occurs if storage device 12 is stolen), storage device 12 fails to detect the appropriate security token and takes action to protect the stored data. The appropriate action varies from simply locking storage device 12 to erasing all data on storage device 12.

By using a combination of two separate but communicating devices to protect data, the present system ensures data security even if storage device 12 is lost or stolen. For example, if a business person needs to travel overseas to conduct business, he or she may choose to store important business information on storage device 12. If storage device 12 is of a relatively large form-factor, it may be convenient to place storage device 12 into a briefcase or other luggage during the journey. Key 14, however, is kept separate from storage device 12 and may be attached to a key-ring or otherwise carried by the business person. Using the present system, if the luggage (and, consequently storage device 12) is stolen, storage device 12 will lock or erase the data when storage device 12 loses communication with key 14. Accordingly, storage device 12 detects that key 14 is unavailable indicating storage device 12 has been stolen and takes unilateral action to protect the business information.

In an alternative embodiment, storage device 12 is integrated into a computer and operates as one of the computer's storage drives. Key 14 for the storage device 12 is mounted to the motherboard of the computer and communicates with storage drive 12 to allow operation of the computer system and provide access to the contents of storage drive 12. In a conventional computer system with no key 14, if the hard drive is removed from the computer system, it can easily be placed into another computer system and all the data on the hard drive may be accessed. In computer systems that have hot-swappable or easily removed hard drives, it is particularly easy for hard drives to be stolen and accessed via another computer system. In the present embodiment, however, because key 14 is mounted to the motherboard of the computer system, after theft of storage device 12, key 14 no longer communicates with storage drive 12. Without key 14, storage drive 12 locks or erases the data on storage device 12 making it inaccessible. If storage device 12 is inserted into another computer, the data on storage device 12 cannot be read because the appropriate key 14 is unavailable.

As shown in FIG. 2, storage device 12 and key 14 communicate via communication medium 16 to protect the data on storage device 12. By default, storage device 12 prevents access to data stored on storage device 12. However, when key 14 and storage device 12 are brought into close proximity and are able to communicate, key 14 transmits a security token to storage device 12 causing it to enable access to the stored data. In one embodiment, storage device 12 includes a conventional portable storage system with a built-in processor and antenna for communicating with key 14 via wireless communication medium 16. Key 14 is fabricated in a similar and convenient way to carry form factor and includes an antenna for communicating with storage device 12. Key 14 also includes software code for sending commands or security tokens to storage device 12 causing it to either make available or lock the stored data.

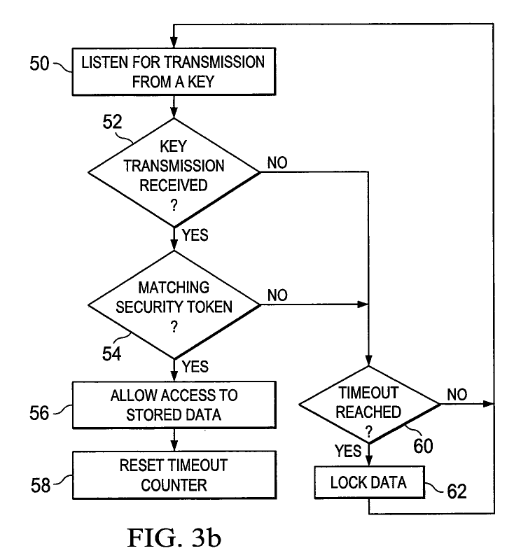

Referring to FIG. 3a, secure portable memory system 20 is illustrated. The secure memory system 20 includes storage device 22 and key 24. Storage device 22 and key 24 operate together to protect the data on storage device 22. Storage device 22 does not allow access to the data unless the storage device has received the appropriate security token from key 24 within a pre-determined timeframe. If storage device 22 fails to receive the security token from key 24, storage device 22 unilaterally takes action to protect the data stored on storage device 22 by locking the device, erasing the data, encrypting the data, or otherwise preventing access to the data. Accordingly, the data on storage device 22 cannot be accessed without key 24. An attacker that wishes to retrieve the data from storage device 22 must have possession of both the storage device and the key.

Storage device 22 includes electronic memory 26 for storing information. Memory 26 is connected to controller 28. Controller 28 interacts with memory 26 to store and retrieve values from and to erase portions of memory 26. Controller 28 also receives data requests from external system components via connector 30. Connector 30 includes USB adapters, hard drive connectors such as ATA or SCSI adapters, or other electronic data-transfer connectors. To provide environmental and shock protection, the various components of storage device 22 are encapsulated using polymer resin, thermal resin, or other encapsulating material. When storage device 22 is unlocked, a request for data is received by controller 28 via connector 30. Controller 28 receives the request and retrieves data from memory 26 in accordance with the request. After retrieving the data from memory 26, controller 28 communicates the data to the requesting system component via connector 30. Storage device 32 includes antenna or communication device 32 for receiving wireless communications from key 24. Processor 34 is connected to antenna 32 for receiving and interpreting the wireless communications. If processor 34 detects the correct security token transmitted by key 24, processor 34 communicates with controller 28 or memory 26 to allow storage device 22 to operate and to provide data access to external systems for a pre-determined length of time. If, however, processor 34 receives a communication from key 24 instructing storage device 22 to lock the data, or if processor 34 determines that key 24 is unavailable, processor 34 bypasses controller 28 and communicates directly with memory 26 to lock the data. Depending upon the application, processor 34 may take any appropriate action to lock the data to limit access, including erasing all or portions of memory 26, disabling controller 28 or memory 26 to prevent access to the data, enabling password-protection for storage device 22, or encrypting all or a portion of memory 26. Processor 34 may implement one or more of these or other techniques for preventing unauthorized access to the data on storage device 22. The data may be permanently locked, locked for a pre-determined amount of time, or locked pending receipt of an appropriate communication from key 24.

Key 24 is configured to communicate with storage device 22 via a wireless communication medium. Key 24 includes memory 36 for storing software code for controlling the operation of key 24. Processor 40 is connected to memory 36 and retrieves and executes the stored instructions. Processor 40 is connected to antenna or communication device 38 for transmitting information to storage device 22. Key 24 is configured to transmit a security token or commands and instructions to storage device 22 via antenna 38. Key 24 may also include an external user interface 42 that is connected to processor 40 for receiving input from a user and communicating corresponding commands to storage device 22.

Storage device 22 and key 24 communicate via a communication medium. The communication medium may include a wired connection formed between storage device 22 and key 24. Wired connections include Ethernet or networking cables, optical cables, and metal traces formed over a circuit board between key 24 and storage device 22. However, in the present embodiment, the communication medium is wireless and may include 802.11, Bluetooth, radio-frequency, or other wireless communication technologies. The communication medium allows for two-way half or full-duplex communication between storage device 22 and key 24. In alternative embodiments, however, the communication is one-way, with key 24 being configured to transmit data to storage device 22, but storage device 22 being unable to transmit information to key 24.

In the present embodiment, each storage device 22 is configured to operate with a single key 24. Each key 24 has a unique security token stored in memory 36 which is also made known to storage device 22. The security token may be stored in memory 26 of storage device 22 or in an auxiliary memory device within storage device 22. Storage device 22 will only allow access to the stored data if a key 24 transmits the matching security token to storage device 22 within a predetermined time frame. During operation of secure storage system 20, storage device 22 continually listens to the communication medium to determine whether any keys 24 are within broadcast range of storage device 22 and are transmitting security tokens. If so, storage device 22 inspects any received security tokens. If any of the security tokens match the value stored on storage device 22, storage device 22 allows access to the data. If storage device 22 determines that the appropriate key 24 is unavailable, however, storage device 22 takes unilateral action to protect the data on the storage device. The action may include locking or encrypting the data, erasing the data using multi-write erase algorithms, or otherwise making the data unavailable or difficult to access. In alternative embodiments, a plurality of storage devices 22 may be secured by a single key 24, or a single key 24 may operate to control access to a plurality of storage devices 22. In a further alternative embodiment, a plurality of different keys 24 having different security tokens must be in communication with storage device 22 before storage device 22 can be accessed.

Depending upon the implementation, the security token of key 24 includes any information that can be transmitted to storage device 22 to identify key 24 or otherwise enable access to the data. For example, the security token may be a unique ID that is assigned to each key 24. In that case, each storage device 22 is provided with the ID of its corresponding key 24. As the system operates, each key 24 continually broadcasts its own ID. If storage device 22 receives the ID of its corresponding key 24, it will unlock the data and allow access. In another embodiment, wherein the data on storage device 22 is encrypted, the security token may include a decryption key that storage device 22 uses to access the data. In that case, upon locking the data, storage device 22 removes any traces of the decryption key to prevent unauthorized access. In other embodiments, the security token has a dynamic value. In one embodiment, both storage device 22 and key 24 are provided with an initial seed value. Based upon that seed value, each device calculates the same series of pseudo-random numbers. A new number is calculated every thirty seconds, for example. At any given time, key 24 calculates the number for that time slot and broadcasts it to storage device 22. If the number received from key 24 matches the number calculated by storage device 22 for the same time slot, storage device 22 allows access to the data.

Key 24 may also broadcast commands or other data via antenna 38 to storage device 22. Key 24 may be configured to transmit commands to storage device 22 causing it to lock the data even if both key 24 and storage device 22 are in communication. In one example, processor 40 of key 24 includes software logic to prevent access to the data during certain time periods. Upon entering a data-lock time period, key 24 sends a command to storage device 22 instructing it to lock the data. Alternatively, key 24 may periodically transmit a command to storage device 22 instructing it to request password entry before allowing access to the data. The command is sent after the device has been unlocked by key 24 for a pre-defined period of time. For example, in high-security situations, even if key 24 is present to allow access to storage device 22, key 24 instructs storage device 22 to request password entry every 30 minutes. The instruction prevents unauthorized access to storage device 22, even if storage device 22 is in communication with key 24.

Key 24 includes external user interface 42 connected to processor 40 for receiving input from a user. In one embodiment, user interface 42 includes a ‘panic’ button mounted to an exterior portion of key 24. If a user presses the panic button, processor 40 of key 24 immediately broadcasts a command via antenna 38 to storage device 22 instructing it to begin erasing all data stored in memory 26. To ensure successful erasure, processor 34 of storage device 22 writes random data to all cells of memory 26 multiple times. In alternative embodiments, user interface 42 provides buttons or other mechanical interface devices for causing key 24 to issue other commands to storage device 22. Example commands include instructing storage device 22 to demand a password before allowing access to the data, causing storage device 22 to erase data having a defined secrecy level, or causing storage device 22 to encrypt all data stored on the device.

User interface 42 of key 24 includes a mechanism for allowing a user to disable key 24 transmissions without permanently disabling access to the data on storage device 22. For example, storage device 22 may be configured to permanently disable access to the data after it loses communication with key 24 by erasing all stored data. However, if storage device 22 is to be transported via a commercial aircraft, for example, the airline may require that all electronic devices be turned off during the flight. If key 24 is simply turned off during the flight, all data on storage device 22 will be lost after storage device 22 fails to detect a transmission from key 24. Accordingly, user interface 42 includes a button that disables key 24 transmission, while preserving the data. Upon activating the button, key 24 broadcasts a command to storage device 22 instructing it to encrypt and not erase the data. Storage device 22 remains in this state until the user, via user interface 42, instructs key 24 to resume normal operations. Key 24 sends a broadcast command to storage device 22 instructing it to resume normal operations. Storage device 22 receives the communication from key 24, and listens for continuous security token broadcasts from key 24. If storage device 22 loses communication with key 24 and fails to receive the appropriate storage token, storage device 22 may then erase all data.

Similarly, user interface 42 may include a button or switch for turning off the entire secure storage system 20. With system 20 disabled, storage device 22 operates as a conventional storage device providing no active protection to the data stored thereon. Upon re-activating the system, storage device 22 provides active protection for any data present on storage device 22 at the time the system is enabled.

Storage device 22 may include additional devices or systems to prevent unauthorized access to the data. For example, passive intrusion detections systems such as infrared, wire-mesh, and power-surge detection systems may be connected to storage device 22. The passive detection systems work in conjunction with key 24 to protect the data. When a passive intrusion detection system connected to processor 34 detects unauthorized physical access to the device it can lock the data to prevent the unauthorized access. If storage device 22 determines, for example, that the outer casing of the device has been penetrated, processor 34 of storage device 22 encrypts or erases all the information stored on the device.

FIG. 3b shows a flowchart illustrating an example operation of storage device 22 communicating with key 24 to allow access to stored data. In step 50, storage device 22 listens via the communication medium to determine whether any keys are currently broadcasting. Storage device 22 continuously polls the communication medium to listen for a potential key 24 and may listen to a specific broadcast frequency or may sweep over a range of broadcast frequencies. The polling frequency is also adjusted depending upon power consumption concerns. For example, storage device 22 may be configured to poll the communication medium at a low frequency to minimize power consumption. In one embodiment, storage device 22 polls the communication medium for 1 second every 10 seconds. In a similar manner, keys 24 are configured to broadcast their security tokens or other instructions to storage device 22 at a predetermined frequency. In one embodiment, to ensure accurate communication, key 24 broadcasts at a relatively high frequency. Even if the communication medium is particularly noisy or congested, at a sufficiently high frequency, a minimum number of security token or command broadcasts are ultimately communicated to storage device 22. In one embodiment, the polling frequency of storage device 22 and broadcast frequency of key 24 are offset or staggered to prevent one device from routinely polling or broadcasting over the communication medium while the other device is inactive.

In step 52, storage device 22 determines whether it has received a transmission via the communication medium. If so, storage device 22 must first determine whether the transmission originated from a key 24 and includes a security token. Storage device 22 compares the format of the received communication to that of an appropriate security token. This step ensures that storage device 22 does not analyze all traffic received via the communication medium. If, for example, the communication medium is extremely noisy, or includes other data traffic, storage device 22 may receive many unrelated transmissions from other devices before receiving a legitimate communication from a key 24.

In step 54, after receiving a security token transmission, storage device 22 determines whether the token matches the token assigned to storage device 22. If the security tokens match, then the key 24 for storage device 22 has been detected and storage device 22 allows access to the data in step 56. To ensure security, access to the data is only enabled for a pre-determined period of time. Accordingly, in step 58, at the time data access is granted, storage device 22 resets a data-access count-down timer. In one embodiment, for example, shortly after receiving the appropriate security token, the count-down timer is reset to 5 minutes and begins to count down. If storage device 22 does not detect another broadcast of the correct security token within that timeframe, the data on storage device 22 is automatically locked to prevent access.

In step 52, if, after polling the communication medium, storage device 22 does not detect a key transmission, the storage device 22 checks to see whether the count-down timer has expired in step 60. If the count-down timer has not expired, storage device 22 continues listening for key 24 transmissions. However, if the count-down timer has expired, storage device 22 locks the data in step 62. Similarly, in step 54, if storage device 22 has received a security token, but the security token does not match that assigned to storage device 22, storage device 22 again checks whether the count-down timer has expired in step 60. If the timer has not expired, storage device 22 continues looking for available keys 24. However, if the timer has expired, storage device 22 locks the data in step 62.

After locking the data, storage device 22 may be configured to continue listening for key 24 transmissions. In that case, upon receiving the appropriate security token, storage device 22 unlocks the data and resets the count-down timer in step 58. However, in some embodiments, after the count-down timer of storage device 22 expires a single time, the data is permanently locked—perhaps by erasing all data on storage device 22.

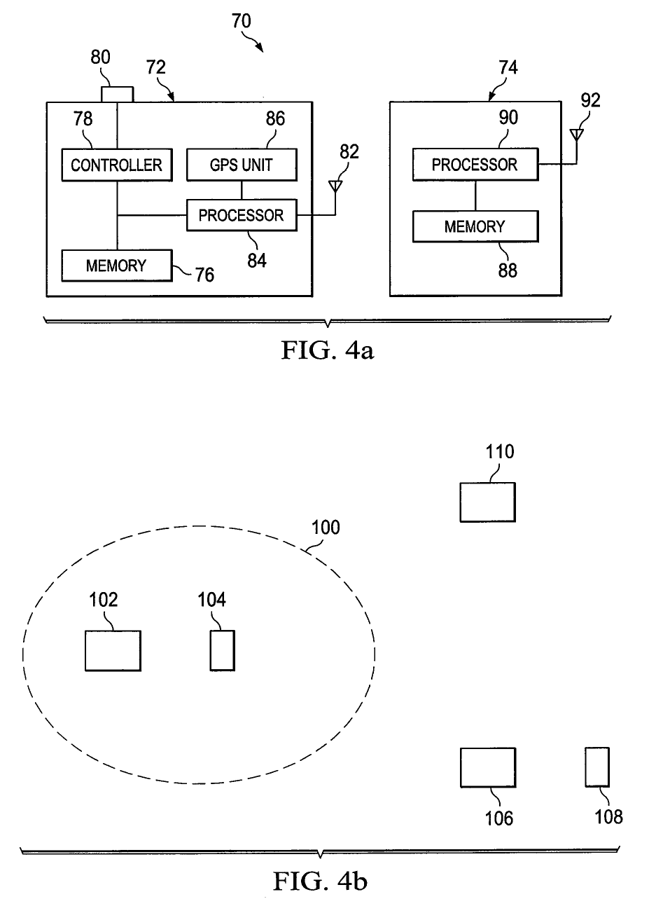

FIGS. 4a and 4b illustrate a second embodiment of a secure storage system wherein the storage device includes a global positioning system (GPS) unit. As shown in FIG. 4a, secure storage system 70 includes storage device 72 and key 74. By default, the data on storage device 72 is locked. To access the data, two separate conditions must be fulfilled. First, key 74 must be brought into communication with storage device 72 to transmit the appropriate security token to storage device 72. Second, storage device 72 must determine that it is located within a pre-defined security zone. If both conditions are met, storage device 72 allows a connected computer system to access the data. If, however, either condition is not met, storage device 72 takes proactive steps to protect the data. Storage device 72 may encrypt or even erase the data to prevent unauthorized access.

Storage device 72 includes electronic memory 76 for storing information. Memory 76 is connected to controller 78. Controller 78 interacts with memory 76 to store and retrieve values from and to erase portions of memory 76. Controller 78 also receives data requests from external system components via connector 80. Connector 80 includes USB adapters, hard drive connectors such as ATA or SCSI adapters, or other electronic data-transfer connectors. Storage device 72 includes antenna or communication device 82 for receiving wireless communications from key 74, however in alternative embodiments storage device 72 and key 74 are directly connected via a cable or wire. Processor 84 is connected to antenna 82 for receiving and interpreting the wireless communications. Storage device 72 includes GPS 86. GPS 86 is connected to processor 84 and is configured to detect a current location of storage device 72 and communicate the current location to processor 84. GPS 86 may include other satellite-based location detection systems such as GLONASS, COMPASS Navigation System, or IRNSS. Alternatively, GPS 86 may rely upon other techniques to determine its current location including celestial navigation or triangulation based upon signals received from ground-based or other transmitters. Processor 84 receives the location data from GPS 86 and determines whether storage device 72 is located within a pre-defined security zone. If processor 84 detects the correct security token transmitted by key 74 and also determines that storage device 72 is located within the security zone, processor 84 communicates with controller 78 or memory 76 to allow storage device 72 to operate and to provide data access to external systems for a pre-determined length of time. If, however, processor 74 receives a communication from key 74 instructing storage device 72 to lock the data, or if processor 84 determines that key 74 is unavailable or storage device 72 is not located within the security zone, processor 84 bypasses controller 78 and communicates directly with memory 76 to lock the data. Depending upon the application, processor 84 may take any appropriate action to lock the data to limit access, including erasing all or portions of memory 76, disabling controller 78 or memory 76 to prevent access to the data, enabling password-protection for storage device 72, or encrypting all or a portion of memory 76. Processor 84 may implement one or more of these or other techniques for preventing unauthorized access to the data on storage device 72. The data may be permanently locked, locked for a pre-determined amount of time, or locked pending receipt of an appropriate communication from key 74.

Key 74 is configured to communicate with storage device 72 via a wireless communication medium. Key 74 includes memory 88 for storing software code for controlling the operation of key 74. Processor 90 is connected to memory 88 and retrieves and executes the stored instructions. Processor 90 is connected to antenna or communication device 92 for transmitting information to storage device 72. Key 74 is configured to transmit a security token or commands and instructions to storage device 72 via antenna 92. Key 74 may also include an external user interface that is connected to processor 90 for receiving input from a user and communicating corresponding commands to storage device 72.

FIG. 4b illustrates several examples of storage devices and keys operating in and around a defined security zone. Security zone 100 can take any shape and/or dimensions and is loaded into the storage devices. Each storage device includes a GPS unit for determining its current location. The storage device compares its current location to security zone 100 to determine whether it is operating within security zone 100. For example, with reference to FIG. 4b, storage device 102 includes a GPS unit. The GPS unit provides storage device 102 with its current location. Storage device 102 compares its current location to security zone 100 and determines that it is operating within security zone 100. Having determined that it is within security zone 100, storage device 102 listens for the appropriate key 104. In this case, key 104 and storage device 102 are in close proximity and storage device 102 and key 104 are able to communicate. Key 104 transmits the correct security token to storage device 102. After receiving the security token, storage device 102 has now determined that it is in security zone 100 and is in communication with the correct key 104. As a result, storage device 102 unlocks the data and allows a computer system to access, modify or delete the data. If, however, storage device 102 is transported outside of security zone 100, or fails to receive the appropriate security token from key 104, it will take action to lock the data and to prevent user access.

As shown in FIG. 4b, although storage device 106 and key 108 are in close proximity and are able to communicate, storage device 106 denies data access because it is not located within security zone 100. To access the data, a user must carry both storage device 106 and key 108 into security zone 100. Similarly, storage device 110 detects that it is not located within security zone 100 and that it is not in communication with an appropriate key. Accordingly, storage device 110 denies data access. To access the data on storage device 110, a user must both carry the device into security zone 100 and place it in communication with the appropriate key.

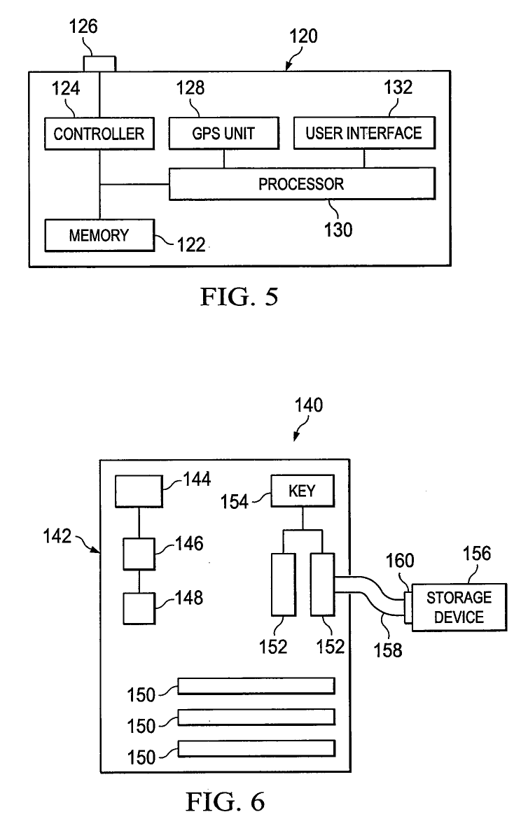

FIG. 5 illustrates another embodiment of the secure storage system including a storage device having a GPS and a user interface for inputting a password or security token. Storage device 120 includes electronic memory 122 for storing information. Memory 122 is connected to controller 124. Controller 124 interacts with memory 122 to store and retrieve values from and to erase portions of memory 122. Controller 124 also receives data requests from external system components via connector 126. Storage device 120 includes GPS 128. GPS 128 determines the current location of storage device 120 and transmits it to processor 130. In alternative embodiments, GPS 128 includes other satellite-based location detection systems such as GLONASS, COMPASS Navigation System, or IRNSS. Alternatively, GPS 128 relies upon other techniques to determine its current location including celestial navigation or triangulation based upon signals received from ground-based or other transmitters. User interface 132 is connected to processor 130 for receiving input from a user and transmitting the input to the processor 130. User interface 132 includes a plurality of buttons or other mechanical input devices and allows a user to enter a security token, password, or other code into user interface 132 to gain access to the data.

Processor 130 receives the location data from GPS 128 and determines whether storage device 120 is located within a pre-defined security zone. Processor 130 also inspects any user input received from user interface 132 to determine whether a user has entered the correct security token. If processor 120 detects the correct security token received from user interface 132 and also determines that storage device 120 is located within the security zone, processor 130 communicates with controller 124 or memory 122 to allow storage device 120 to operate and to provide data access to external systems for a pre-determined length of time. If, however, processor 130 determines that the correct security token has not been received from user interface 132 or storage device 120 is not located within the security zone, processor 130 bypasses controller 124 and communicates directly with memory 122 to lock the data. Depending upon the application, processor 130 may take any appropriate action to lock the data to limit access, including erasing all or portions of memory 122, disabling controller 124 or memory 122 to prevent access to the data, enabling password-protection for storage device 120, or encrypting all or a portion of memory 122. Processor 130 may implement one or more of these or other techniques for preventing unauthorized access to the data on storage device 120. The data may be permanently locked, locked for a pre-determined amounted of time, or locked pending receipt of an appropriate communication from user interface 132.

FIG. 6 illustrates a secure storage system wherein the storage device is connected to a motherboard and the key is mounted directly to the motherboard. Secure storage system 140 includes motherboard 142. In one embodiment, motherboard 142 includes a conventional motherboard. Motherboard 142 includes processor 144, sound processor 146 and video processor 148. The various processors are mounted to a surface of motherboard 142 and are interconnected by conductive traces. Motherboard 142 includes expansion slots 150 for connecting additional system components or devices. In one embodiment, expansion slots 150 include PCI slots for mounting PCI-type cards. Motherboard 142 includes hard drive connectors 152. Hard drive connectors 152 include IDE, ATA, SCSI, or other drive connectors. Key 154 is mounted to a surface of motherboard 142. Traces are formed between key 154 and hard drive connectors 152. Storage device 156 is connected to one of hard drive connectors 152 using cable 158. Storage device 156 includes connector 160 which allows storage device 156 to connect to hard drive connector 152 and to operate as a conventional hard drive. Storage device 156 also communicates with key 154 via cable 158 to receive security tokens to control access to the data on storage device 156. In alternative embodiments, key 154 is mounted directly to motherboard 142, but is not connected to hard drive connectors 152 using conductive traces. Instead, key 154 and storage device 156 communicate using a wireless communication medium. During operation of system 140, storage device 156 is connected to motherboard 142. Key 154 transmits a security token to storage device 156. If the security token matches the security token on storage device 156, storage device 156 allows the computer system to access the data. If storage device 156 is removed from the system, storage device 156 is no longer able to communicate with key 154 to receive the security token and locks the data.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of providing a secure storage system, comprising:
providing a storage device having a communication device and a memory, the communication device being for polling a communication medium;
receiving a security token from the communication medium via the communication device of the storage device;
comparing the security token received from the communication medium to a second security token stored on the storage device;
determining a current location of the storage device;
comparing the current location of the storage device to an approved security zone; and
providing access to the memory if the security token received from the communication medium matches the second security token stored on the storage device and the current location of the storage device lies within the approved security zone.

2. The method of claim 1, including locking the memory if the security token received from the communication medium does not match the second security token stored on the storage device or if the storage device receives a broadcast panic code from the communication medium.

3. The method of claim 1, including resetting a time-out counter after providing access to the memory.

4. The method of claim 2, wherein locking the memory includes erasing the memory of the storage device, changing the encryption key of the storage device, encrypting the memory of the storage device, or setting the storage device to demand a password before allowing access to the memory.

5. The method of claim 1, including:
providing a computer system;
mounting the storage device to the computer system; and
mounting a key to the computer system, the key being configured to communicate a security token via the communication medium.

6. The method of claim 1, wherein the communication medium is wireless.

7. The method of claim 1, wherein the communication medium is wired.

8. A method of providing a secure storage system, comprising:
providing a storage device having a communication device and a memory, the communication device being for polling a communication medium;
receiving a security token from the communication medium via the communication device;
comparing the security token received from the communication medium to a second security token stored on the storage device; and
providing access to the memory if the security token received from the communication medium matches the second security token stored on the storage device.

9. The method of claim 8, including locking the memory if the security token received from the communication medium does not match the second security token stored on the storage device.

10. The method of claim 8, including setting a time-out counter to a non-zero value after providing access to the memory.

11. The method of claim 9, wherein locking the memory includes erasing the memory of the storage device, changing the encryption key of the storage device, encrypting the memory of the storage device, or setting the storage device to demand a password before allowing access to the memory.

12. The method of claim 8, including:
providing a computer system;
mounting the storage device to the computer system; and
mounting a key to the computer system, the key being configured to communicate a security token via the communication medium.

13. The method of claim 8, including providing a key, the key being configured to communicate the security token via the communication medium to control access to a plurality of the storage devices.

14. The method of claim 8, wherein the communication medium is wired.

15. A method of providing a secure storage system, comprising:
providing a storage device;
receiving a security token from a communication medium;
comparing the security token received from the communication medium to a second security token; and
providing access to the storage device if the security token received from the communication medium matches the second security token.

16. The method of claim 15, including locking the storage device if the security token received from the communication medium does not match the second security token.

17. The method of claim 15, including setting a time-out counter to a non-zero value after providing access to the storage device.

18. The method of claim 16, wherein the storage device includes a memory and locking the storage device includes erasing the memory of the storage device, changing the encryption key of the storage device, encrypting the memory of the storage device, or setting the storage device to demand a password before allowing access to the memory of the storage device.

19. The method of claim 15, including:
providing a computer system;
mounting the storage device to the computer system; and
mounting a key to the computer system, the key being configured to communicate a security token via the communication medium.

20. The method of claim 15, wherein the communication medium is wireless.

21. The method of claim 15, wherein the communication medium is wired.

22. A secure storage system, comprising:
a storage device having a communication device and a memory, the communication device being for polling a communication medium; and
a processor for comparing a security token received from the communication medium to a second security token stored on the storage device, the processor providing access to the memory if the security token received from the communication medium matches the second security token stored on the storage device.

23. The secure storage system of claim 22, wherein the processor locks the memory if the security token received from the communication medium does not match the second security token stored on the storage device.

24. The secure storage system of claim 23, wherein the processor is configured to erase the memory of the storage device, change the encryption key of the storage device, encrypt the memory of the storage device, or set the storage device to demand a password before allowing access to the memory of the storage device.

25. The secure storage system of claim 22, including:
a computer system, the storage device being mounted to the computer system; and
a key mounted to the computer system, the key being configured to communicate a security token via the communication medium.
